(19) United States
(12) Patent Application Publication
(10) Pub. No.: US 2025/0371879 A1
(43) Pub. Date: Dec. 4, 2025

(54) INFORMATION PROCESSING DEVICE, INFORMATION PROCESSING METHOD, AND STORAGE MEDIUM

(71) Applicant: CANON KABUSHIKI KAISHA, Tokyo (JP)

(72) Inventors: SEIGO KOJIMA, Tokyo (JP); MASAKAZU FUJIKI, Kanagawa (JP)

(21) Appl. No.: 19/197,134

(22) Filed: May 2, 2025

(30) Foreign Application Priority Data
May 29, 2024 (JP) 2024-087047

(51) Int. Cl. G06V 20/50; G06T 7/70; G06V 10/764

(52) U.S. Cl. CPC G06V 20/50; G06T 7/70; G06V 10/764

(57) ABSTRACT

An information processing device includes: an environment information acquisition unit configured to acquire environment information regarding objects existing in a predetermined region; an object information calculation unit configured to calculate a type of each of the objects and a position of the object relating to one or more of the objects on the basis of the environment information; and a tidying-up details determination unit configured to determine a tidying-up destination of the object on the basis of the type and the position.

### BACKGROUND OF THE INVENTION

### Field of the Invention

The present invention relates to an information processing device, an information processing method, and a storage medium.

### Description of the Related Art

There are techniques for performing a determination concerning whether an object needs to be moved by finding out a position in which the object exists using sensors. Japanese Patent Laid-Open No. 2021-51346 discloses a technique for determining that an object needs to be tidied up if the object exists in a position different from a normal position thereof and informing a user of a device that a tidying-up operation needs to be performed.

Here, in the method described in Japanese Patent Laid-Open No. 2021-51346, determining the details of tidying-up of an object cannot be performed.

### SUMMARY OF THE INVENTION

An information processing device according to an aspect of the present invention includes:

an environment information acquisition unit configured to acquire environment information regarding objects existing in a predetermined region,

an object information calculation unit configured to calculate a type of each of the objects and a position of the object relating to one or more of the objects on the basis of the environment information, and

a tidying-up details determination unit configured to determine a tidying-up destination of the object on the basis of the type and the position.

Further features of the present invention will become apparent from the following description of exemplary embodiments with reference to the attached drawings.

### BRIEF DESCRIPTION OF THE DRAWINGS

FIG. 1 is a diagram showing an example of a usage scene of an information processing device 100 according to First Embodiment.

FIG. 2 is a functional block diagram showing an example of a functional configuration of the information processing device 100 according to First Embodiment.

FIG. 3 is a diagram showing an example of a hardware configuration of the information processing device 100 according to First Embodiment.

FIG. 4 is a flowchart for describing an example of a flow of an overall process of the information processing device 100 in First Embodiment.

FIG. 5 is a diagram showing an example of an image acquired as a region to be tidied up in First Embodiment.

FIG. 6 is a diagram showing an example of a data structure of object data according to First Embodiment.

FIG. 7 is a flowchart for describing an example of a process of calculating an orderliness level according to First Embodiment.

FIG. 8 is a diagram showing an example of data of a connected object in First Embodiment.

FIG. 9 is a diagram showing an example of a data structure of object data at the time of completion of Step S127 in FIG. 7.

FIG. 10 is a flowchart for describing an example of a flow of a process of determining the details of tidying-up in Step S105 in FIG. 4.

FIG. 11 is a diagram showing an example of a list of available placement positions at the time of completion of Step S114 in First Embodiment.

FIG. 12 is a diagram showing an example of a data structure of object data when the process of Step S116 is completed.

FIG. 13 is a diagram showing an example of determining a tidying-up destination on the basis of an image in FIG. 5 in First Embodiment.

FIG. 14 is a functional block diagram showing an example of a functional configuration of the information processing device 100 according to Second Embodiment.

FIG. 15 is a flowchart for describing an example of a flow of a process of determining the details of tidying-up in Second Embodiment.

FIG. 16 is a diagram showing an example of an image acquired as a region to be tidied up in Second Embodiment.

FIG. 17 is a diagram showing an example of an object data structure when an orderliness level is calculated in Step S104 in Second Embodiment.

FIG. 18 is a diagram showing an example of a list of available placement positions at the time of completion of Step S114 in FIG. 15 in Second Embodiment.

FIG. 19 is a diagram showing an example of a list of available placement positions when the process of Step S211 in Second Embodiment is completed.

FIG. 20 is a diagram showing an example of a list of available placement positions after a determination value is calculated in Step S212 in Second Embodiment.

FIG. 21 is a diagram for explaining an example of determining a tidying-up destination on the basis of an image in FIG. 16 in Step S212 in FIG. 16 in Second Embodiment.

FIG. 22 is a flowchart for describing an example of a flow of orderliness level calculation in Step S104 in Third Embodiment.

FIG. 23 is a diagram showing an example of an image acquired as a region to be tidied up in Step S102 in Third Embodiment.

FIG. 24 is a diagram showing an example of a data structure of object data derived in Step S103 in Third Embodiment.

FIGS. 25A and 25B are diagrams showing examples of reference object data and data regarding a “position of rules” in Third Embodiment.

FIG. 26 is a flowchart for describing an example of a flow of linking an object and a “position of rules” in Step S314 in Third Embodiment.

FIG. 27 is a diagram showing an example of table data of a distance between a “position of rules” and a position of object data created in Step S322 in Third Embodiment.

FIG. 28 is a diagram showing an example of a data structure of object data when the process of Step S323 is completed in Third Embodiment.

FIG. 29 is a diagram showing an example of a data structure of object data when the process of Step S334 in Third Embodiment is completed.

FIG. 30 is a flowchart for describing an example of a flow of determining the details of tidying-up in Third Embodiment.

FIG. 31 is a diagram showing an example of an example of determining a tidying-up destination on the basis of an image in FIG. 23 in Third Embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

In Present Embodiment, an example in which an unordered object is detected on the basis of an image captured by a network camera and a movement destination thereof is determined will be explained.

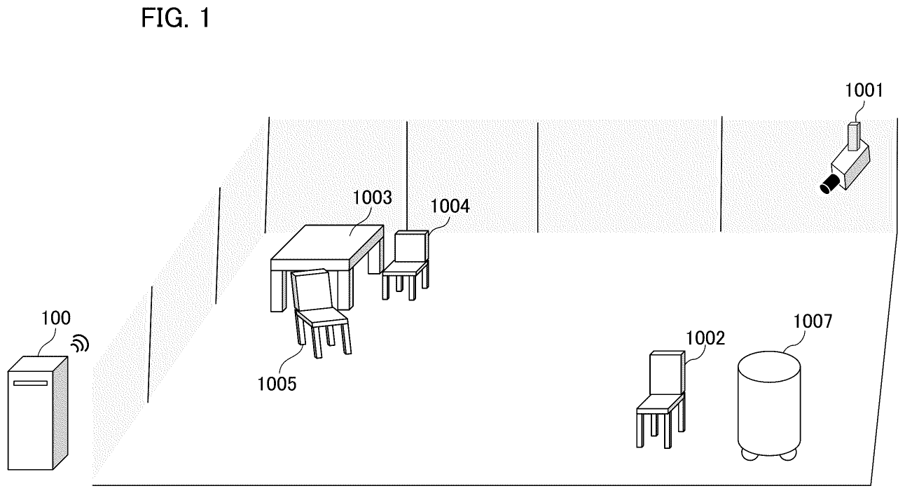

FIG. 1 is a diagram showing an example of a usage scene of an information processing device 100 according to First Embodiment and shows a space in a building that has been set as a target for tidying up. It is assumed in Present Embodiment that tidying up is performed using a tidying-up robot.

In Present Embodiment, a state in which similar objects are located close to each other together is determined as a tidied-up state and a tidied-up state of each of the objects is converted into a numerical value so that the numerical value is determined to be an orderliness level. Furthermore, in Present Embodiment, a network camera 1001 acquires information concerning objects in a space in a building.

In Present Embodiment, a tidying-up destination of a chair 1002 is determined to be a position around positions of a desk 1003, a chair 1004, and a chair 1005. Reference numeral 100 corresponds to an information processing device such as a PC which performs processes relating to the processes in Present Embodiment and causes a robot 1007 to move a chair as an object.

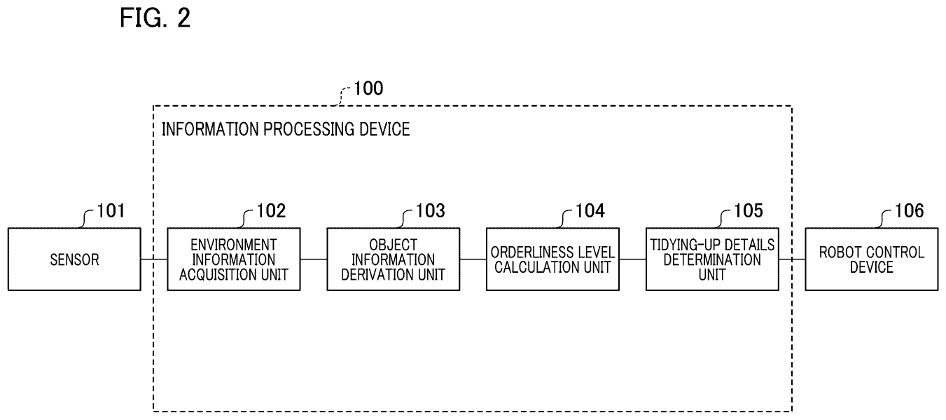

FIG. 2 is a functional block diagram showing an example of a functional configuration of the information processing device 100 according to First Embodiment. Some of the functional blocks shown in FIG. 2 are realized by causing a CPU or the like serving as a computer included in the information processing device to execute a computer program stored in a memory serving as a storage medium.

Here, some or all of these may be realized using hardware. As the hardware, a dedicated circuit (ASIC), a processor (reconfigurable processor, DSP), or the like can be used.

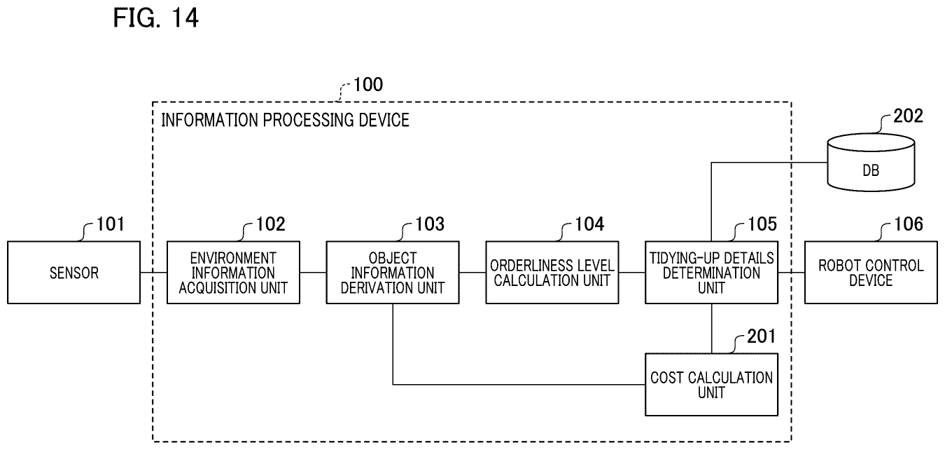

Furthermore, the functional blocks shown in FIG. 2 need not to be built in the same housing and may be configured of separate devices connected to each other via signal paths. Similarly, the above explanation provided with reference to FIG. 2 applies to FIG. 14.

The information processing device 100 according to Present Embodiment includes an environment information acquisition unit 102, an object information derivation unit 103, an orderliness level calculation unit 104, and a tidying-up details determination unit 105. Furthermore, a sensor 101 and a robot control device 106 are connected to the information processing device 100 over a wireless network.

In Present Embodiment, the sensor 101 is, for example, the network camera 1001. The network camera 1001 captures an image of a region on which tidying-up is performed (hereinafter, a region which is subjected to tidying-up will be referred to as a “region to be tidied up”).

The environment information acquisition unit 102 acquires information regarding a region to be tidied up from images captured using the sensor 101. The environment information acquisition unit 102 acquires environment information regarding an object existing in a predetermined region.

The object information derivation unit 103 subjects, to image recognition, one or more objects existing in the region to be tidied up from the information regarding the region to be tidied up acquired using the environment information acquisition unit 102 and derives a position and type information of each object.

The object information derivation unit 103 functions as an object information calculation unit which calculates a type of object and a position of the object regarding one or more objects on the basis of the environment information.

The orderliness level calculation unit 104 calculates an orderliness level of each object existing in the region to be tidied up on the basis of the information regarding the position and the type of the object derived using the object information derivation unit 103. That is to say, the orderliness level calculation unit 104 calculates an orderliness level of each of objects on the basis of the relevance of the types and the distances of the objects.

The tidying-up details determination unit 105 determines the details of tidying up to be performed in a region (for example, a tidying-up destination) on the basis of the orderliness level of the object calculated using the orderliness level calculation unit 104. That is to say, the tidying-up details determination unit 105 determines a tidying-up destination for an object on the basis of the type and the position of the object.

The robot control device 106 controls the operation of the robot to move an object on the basis of the details determined by the tidying-up details determination unit 105. The robot control device 106 functions as a moving unit which moves an object to a tidying-up destination on the basis of the tidying-up destination determined by the tidying-up details determination unit 105.

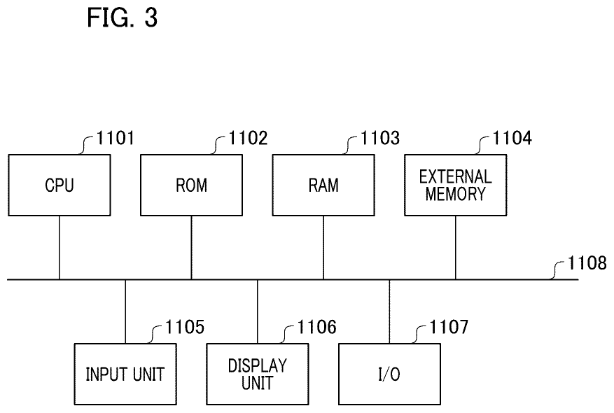

FIG. 3 is a diagram showing an example of a hardware configuration of the information processing device 100 according to First Embodiment. Reference numeral 1101 corresponds to a CPU as a computer and controls various devices connected to a system bus 1108. Reference numeral 1102 corresponds to a ROM and stores a program for a BIOS and a boot program and reference numeral 1103 corresponds to a RAM and is used as a main storage device for reference numeral 1101 that is a CPU.

Reference numeral 1104 corresponds to an external memory such as a HDD or an SSD and stores programs processed by the information processing device 100. An input unit 1105 includes a keyboard, a mouse, and a robot controller and performs a process relating to an input of information or the like. A display unit 1106 outputs the calculation results of the information processing device 100 to a display device. The display device may be of any type such as an LCD display, a projector, or an LED indicator.

Reference numeral 1107 corresponds to an I/O, performs information communication via a communication interface. In addition, the communication interface may be Ethernet or any type of interface such as a USB, serial communication, or wireless communication. The I/O 1107 receives output information from various sensors or other information processing devices.

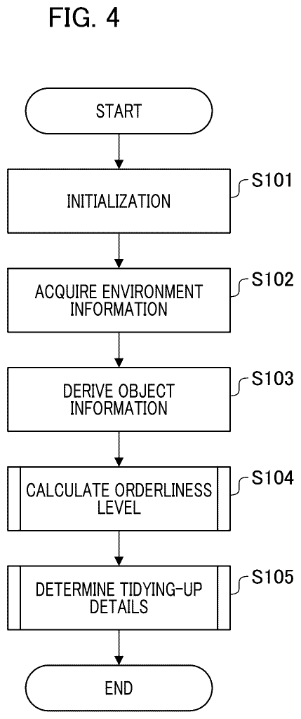

FIG. 4 is a flowchart for describing an example of a flow of an overall process of the information processing device 100 in First Embodiment. The CPU 1101 serving as a computer of the information processing device 100 executes a computer program stored in a memory, thereby sequentially performing the operations of each step in the flowchart of FIG. 4. The process flow of FIG. 4 starts when the information processing device 100 is started up.

In Step S101, the initialization of the information processing device 100 is performed. That is to say, a computer program is read from an external memory 1104 and the information processing device 100 is brought into an operable state. Furthermore, if necessary, various pieces of setting information are read from the ROM 1102. The setting information includes information regarding connected (i.e. relevant) objects which will be described later.

In Step S102, the environment information acquisition unit 102 acquires an image acquired using the sensor 101 as a region to be tidied up and divides the image into a grid of, for example, 10 cm squares. Here, the process of Step S102 functions as an environment information acquisition step of acquiring environment information regarding an object existing in a predetermined region.

Each grid has coordinates (x, y) and the coordinates of the grid in the upper left of the image are set as the origin of coordinates (0, 0). It is assumed that the right direction is an x-axis, the vertical direction is a y-axis, and the number of grids in each direction from the origin is the coordinate of each grid.

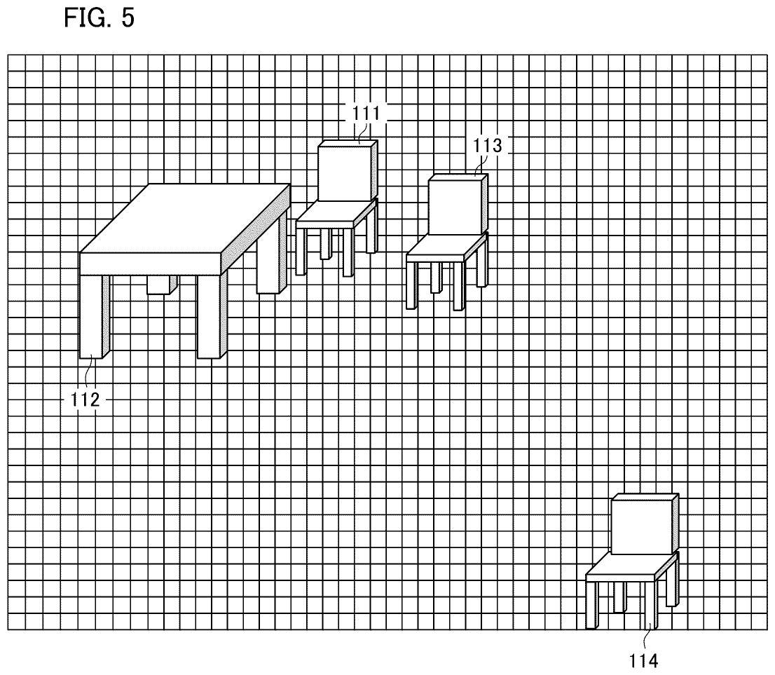

FIG. 5 is a diagram showing an example of an image acquired as a region to be tidied up in First Embodiment, and shows an example of an image acquired in Step S102 above. The grid need not be 10 cm square.

In Step S103, the object information derivation unit 103 derives objects existing in the region to be tidied up on the basis of the image acquired using the environment information acquisition unit 102 in Step S102.

That is to say, the characteristics of a desk and a chair that are tidying-up targets are registered in advance, and then an object recognition process is used for extracting objects which match the characteristics of the desk and the chair which exist in the image. Here, the process of Step S103 functions as an object information calculation step of calculating the type and the position of one or more objects on the basis of the environment information.

Furthermore, when an object is extracted, object data including an “identification number,” a “type,” “coordinates of the four corners,” a “position,” an “orderliness level,” a “tidying-up position,” and an “initial position” of the object are stored, for example, in the external memory 1104.

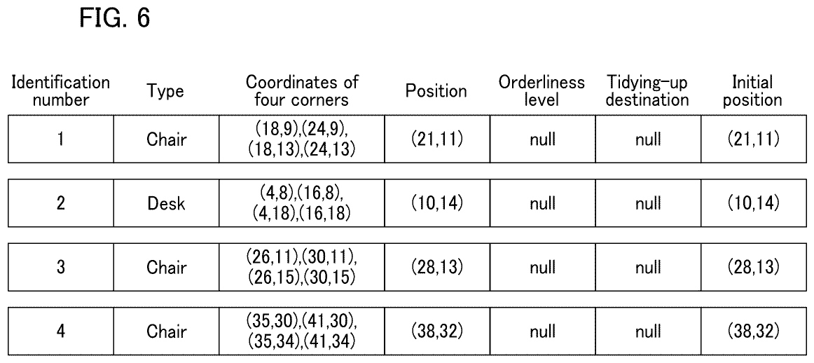

FIG. 6 is a diagram showing an example of the data structure of object data according to First Embodiment and shows an example of a data structure of object data derived in Step S103 on the basis of the image acquired in Step S102. As shown in FIG. 6, each object data is linked to data such as an “identification number,” a “type,” “coordinates of the four corners,” a “position,” an “orderliness level,” a “tidying-up destination,” and an “initial position.”

In FIG. 6, an “identification number” is an integer. In addition, the first extracted object is defined to be 1, the subsequently extracted object is defined to be 2, the subsequently extracted object is defined to be 3, and the numbers are determined in the order in which they are extracted. If the characteristics of the object extracted through image recognition match those of a desk, a “type” is stored as a “desk”, and if they match those of a chair, the “type” is stored as a “chair” in, for example, the external memory 1104.

“Coordinates of the four corners” are used for storing data regarding the coordinates (x, y) of the four corners. That is to say, the grid occupied by the object is approximated by a rectangle and the coordinates of the four grid points where the vertices of the rectangle are located are stored. A “position” corresponds to the center of gravity of the “coordinates of the four corners.”

An “orderliness level” is a variable and the details thereof will be described later. In Step S103, the value is set to NULL. A “tidying-up position” corresponds to data regarding coordinates (x, y) and the coordinates are determined when the tidying-up destination of the object is determined. In Step S103, the value is set to NULL.

An “initial position” is used for storing the same coordinates (x, y) as the “position” acquired in Step S103. For example, a chair 111 shown in FIG. 5 is, for example, extracted as Identification Number 1, a desk 112 is extracted as Identification Number 2, a chair 113 is extracted as Identification Number 3, and a chair 114 is extracted as Identification Number 4.

In Step S104, the orderliness level calculation unit 104 calculates an orderliness level of each object in the region to be tidied up on the basis of the object data derived in Step S103 and stored in, for example, the external memory 1104.

One identification number of object data whose orderliness level is NULL is selected and the orderliness level of the object is executed in Step S104. In addition, if the process of Step S104 is completed for all identification numbers, the process proceeds to the process of Step S105. The details of the process in Step S104 will be described in detail later.

In Step S105, the tidying-up details determination unit 105 determines the tidying-up details on the basis of the orderliness level of the object calculated in Step S104. The details of the process in Step S105 will be described in detail later. Here, the process of Step S105 functions as a tidying-up details determination step of determining a tidying-up destination of the object on the basis of the type and the position of the object.

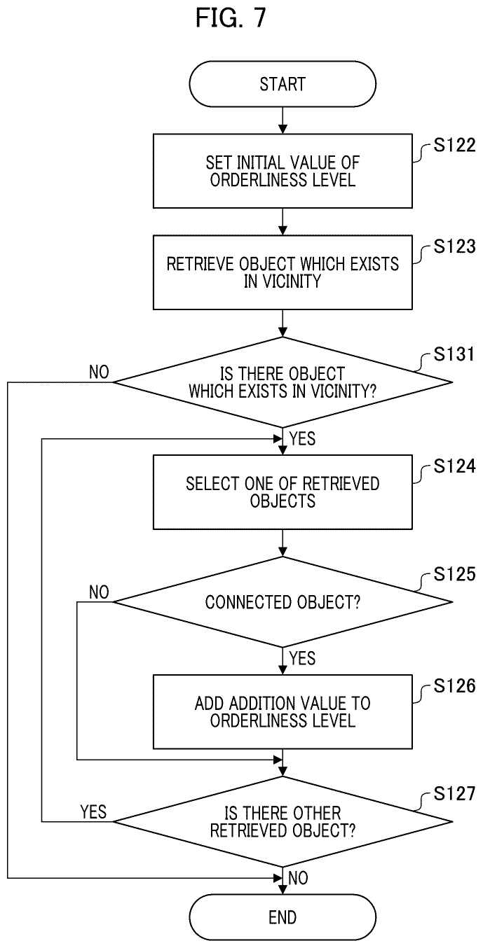

FIG. 7 is a flowchart for describing an example of a process of calculating an orderliness level according to First Embodiment and shows an example of a procedure for calculating an orderliness level of one object in Step S104. The CPU serving as a computer of the information processing device 100 executes a computer program stored in a memory, thereby sequentially performing the operations of each step in the flowchart of FIG. 7.

First, a description will be provided assuming that the selected identification number is 1. In Step S122, an initial value of the orderliness level is set. A value of an orderliness level value of object data whose identification number is 1 is set as an initial value, for example, 0.

In Step S123, all objects existing in the vicinity of the object are retrieved. For this reason, first, a position of object data whose identification number is 1 is acquired. The acquired coordinates are (21, 11) as shown in FIG. 6. Subsequently, an identification number except for 1 is designated. The explanation will be provided assuming that the designated identification number is 2. A position of object data whose identification number is 2 is acquired.

The acquired coordinates are (10, 14). A distance between two points of a position (21, 11) of object data whose acquired identification number is 1 and a position (10, 14) of object data whose acquired identification number is 2 is calculated. The distance is calculated by applying Pythagoras' theorem to the coordinates of the two acquired position points and multiplying it by a length of one side of the grid (10 cm).

Since a position is the center of gravity of the object, the position corresponds to the distance between the centers of gravity. In the case of the above example, the distance between the two points is 114 cm. If the calculated distance is within a predetermined threshold value, the designated identification number 2 is stored in a list of “identification numbers of objects existing in the vicinity.”

All identification numbers (2 to 4) except for 1 are designated and the process of Step S123 is performed. In Present Embodiment, the above predetermined threshold value is set to, for example, 150 cm. When the process of Step S123 is completed, Identification Numbers 2 and 3 are stored in the list of “identification numbers of objects existing in the vicinity.”

In Step S131, it is determined whether there is an object which exists in the vicinity. That is to say, it is determined whether there are one or more identification numbers of the object in the list of “identification numbers of objects existing in the vicinity” retrieved in Step S123. In addition, if the one or more identification numbers exist, the process proceeds to the process of Step S124, and if the one or more identification numbers do not exist, the process flow of FIG. 4 is completed.

In Step S124, one unselected identification number is selected from the list of “identification numbers of objects existing in the vicinity” retrieved in Step S123. The explanation will be provided using a case where the selected identification number is 2 as an example.

In Present Embodiment, a read-only relational database which uses a “type of object” and a “type of connected (i.e. relevant) object” as data of the “connected (i.e. relevant) object” as a composite primary key and outputs an addition value that is a constant is stored in the ROM 1102. In Present Embodiment, the relational database is used in Step S124. The above addition values will be described in detail later.

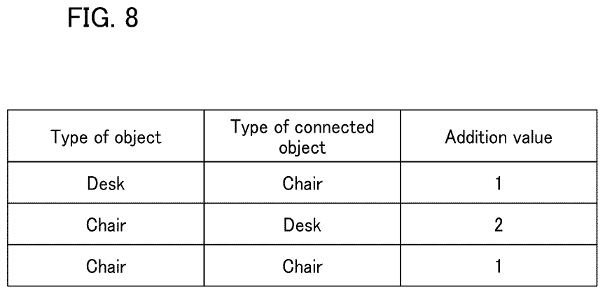

FIG. 8 is a diagram showing an example of data of the “connected object” in First Embodiment. If a desk is retrieved as the “type of object” and a chair is retrieved as the “type of connected object,” 1 is output as the addition value.

If a chair is retrieved as the “type of object” and a desk is retrieved as the “type of connected object,” 2 is output as the addition value. If a chair is retrieved as the “type of object” and a chair is retrieved as the “type of connected object,” 1 is output as the addition value.

Also, in the example of FIG. 8, if a desk is retrieved as the “type of object” and a desk is retrieved as the “type of connected object,” the addition value is not retrieved. In the example shown in FIG. 8, the “type of object” and the “type of connected object” are only a “desk” and a “chair,” but are not limited to these.

In Step S125, a determination concerning connected objects is performed. Here, for example, the type (chair) of the object data whose identification number is 1 and the type (desk) of the object data whose identification number is 2 are acquired.

Moreover, the chair is designated as the “type of object,” the desk is designated as the “type of connected object,” and retrieving is performed. If an addition value is retrieved as a result of the retrieving, it is determined that there is a connected object and the process proceeds to the process of Step S126, and if an addition value is not retrieved, the process proceeds to the process of Step S127. In the above example, since addition value (2) is retrieved, the process proceeds to the process of Step S126.

The above-described addition value is a value to be added to an orderliness level if a connected object exists in the vicinity. In Step S126, the addition value is added to the orderliness level. That is to say, the orderliness level (initial value 0) of the object data whose identification number is 1 is acquired and 2 is calculated as a value obtained by adding the acquired orderliness level (0) to the addition value (2) retrieved in Step S125. Thus, the orderliness level of the object data whose identification number is 1 is updated to 2.

In this way, Steps S125 and S126 function as orderliness level calculation steps (orderliness level calculation unit) of calculating the orderliness level on the basis of the relevance of the types and the distances of the plurality of objects. Furthermore, based on the orderliness level, a tidying-up destination for the object is determined in Step S105. The tidying-up destination is determined so that the orderliness level increases.

Furthermore, in Present Embodiment, the calculation is performed so that, as the relevance increases, the orderliness level increases. For example, in calculating the orderliness level, the orderliness level may be calculated on the basis of the regularity of the position relationships of a plurality of objects, so that, for example, as the regularity increases, the orderliness level increases.

In Step S127, it is determined whether any other objects have been retrieved. That is to say, it is determined whether there exists one or more elements which have not been selected in Step S124 in the list of “identification numbers of objects existing in the vicinity” retrieved in Step S123.

Also, if it is determined in Step S127 that the object exists, the process proceeds to the process of Step S124. In addition, if it is determined that the object does not exist, all elements are deleted from the list of “identification numbers of objects existing in the vicinity” and the process flow of FIG. 4 is completed.

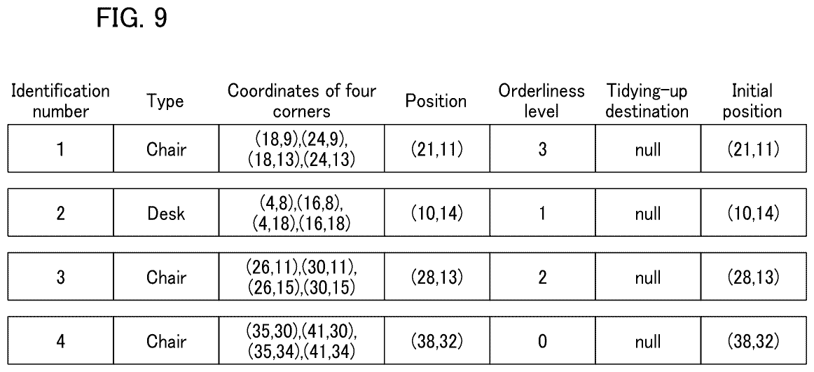

FIG. 9 is a diagram showing an example of a data structure of object data at the time of completion of Step S127 in FIG. 7. As shown in FIG. 9, by performing the flow in FIG. 7, as the related objects increase in the vicinity and as the addition values are accumulated, the orderliness level increases.

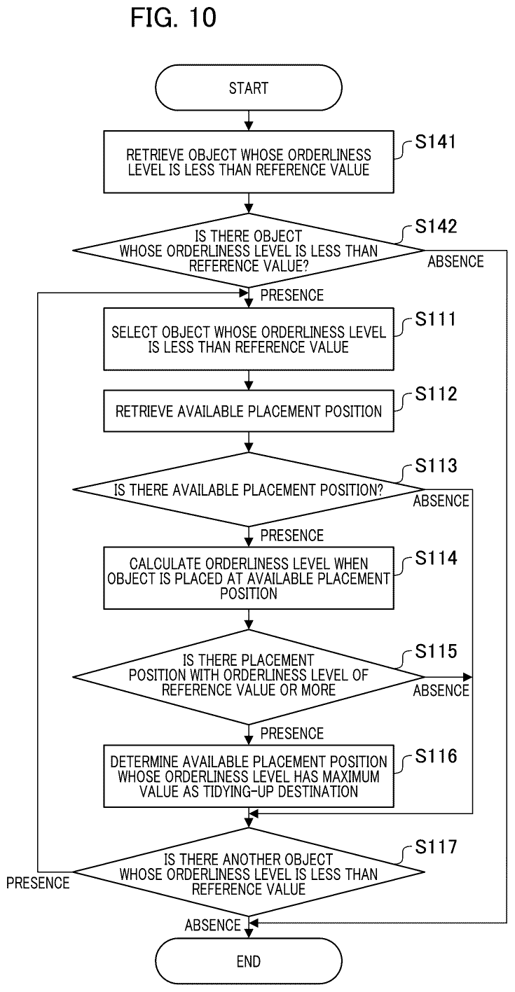

FIG. 10 is a flowchart for describing an example of a flow of a process of determining the details of tidying-up in Step S105 of FIG. 4 and shows an example of a procedure of determining the tidying-up details in Step S105. The CPU serving as a computer of the information processing device 100 executes a computer program stored in a memory, thereby sequentially performing the operations of each step in the flowchart of FIG. 10.

In Step S141, an object whose orderliness level is less than a reference value is retrieved. That is to say, any one of the identification numbers is designated and the orderliness level of the object data of the designated identification number is referenced. If the referenced orderliness level is less than a predetermined reference value, the designated identification number is stored in a list of “identification numbers of objects whose orderliness level is less than the reference value.”

After the process of step S141 has been completed for all identification numbers, the process proceeds to the process of Step S142. In Present Embodiment, since the reference value is 1 and the orderliness level of the object data of Identification Number 4 is 0, 4 is added to the list of “identification numbers of objects whose orderliness level is less than the reference value.”

In Step S142, it is determined whether there is an object whose orderliness level is less than the reference value. That is to say, it is determined whether one or more elements exist in the list of “identification numbers of objects whose orderliness level is less than the reference value” retrieved in Step S141. If it is determined that the one or more elements exist, the process proceeds to the process of Step S111, and if it is determined that the one or more elements do not exist, the process flow of FIG. 10 is completed.

In Step S111, an object which is less than the reference value is selected. That is to say, one unselected identification number is selected from the list of “identification numbers of objects whose orderliness level is less than the reference value.” Here, the selected identification number is 4.

In Step S112, available placement positions are retrieved. That is to say, a place in which an object can be disposed is retrieved in a region to be tidied up. Based on the object data acquired in Step S103, the coordinates of the four corners [(35, 30), (41, 30), (35, 34), (41, 34)] and a position (38, 32) of the object data whose identification number is 4 are acquired.

Moreover, one grid is designated from the grids in the image and the coordinates (x, y) of the grid are acquired. Here, the explanation will be provided assuming that the coordinates of the designated grid are (20, 18).

Subsequently, a difference between the coordinates (38, 32) of the above-described position and the coordinates (20, 18) of the selected grid is calculated. The difference is (−18, −14). Subsequently, the four coordinates of the four corners described above are shifted by the difference described above and the four coordinates described above are stored as “coordinates of the four corners after movement.”

The “coordinates of the four corners after movement” are [(17, 16), (23, 16), (17, 20), (23, 20)]. All four coordinates of the “coordinates of the four corners after movement” match any of the coordinates of the grid acquired in Step S102.

Furthermore, if the four sides composed of the four coordinates of the “coordinates of the four corners after movement” and the four sides composed of the coordinates of the four corners of object data with an identification number other than 4 do not overlap each other, the coordinates of the designated grid are stored as a list of available placement positions. The coordinates (20, 18) of the designated grid satisfy the above conditions, and are thus added to the list of available placement positions.

On the other hand, for example, if a grid with the coordinates (20, 9) is designated, since the four sides composed of the “coordinates of the four corners after movement” and the four sides composed of the coordinates of the four corners in the object data of Identification Number 1 overlap each other, the coordinates of the grid are not added to the list.

Also, for example, if a grid with the coordinates (0, 3) is designated, the “coordinates of the four corners after movement” are [(−3, 1), (3, 1), (−3, 5), (3, 5)]. Therefore, since the coordinates (−3, 1) and (−3, 5) which do not match any grid coordinates are included, the coordinates of the grid are not added to the list.

If all grids are designated sequentially and the process of Step S112 is performed and is completed, the process proceeds to the process of Step S113. An explanation will be provided using four coordinates (20, 18), (14, 4), (10, 30), and (37, 31) from the list of available placement positions stored at the time of end of Step S112 as examples.

In Step S113, it is determined whether there is an available placement position. That is to say, it is determined whether one or more elements exist in the list of available placement positions retrieved in Step S112. If it is determined that the one or more elements do not exist, the process proceeds to the process of Step S117. On the other hand, if it is determined that the one or more elements exist, the process proceeds to the process of Step S114.

In Step S114, an orderliness level when an object is placed at an available placement position is calculated. That is to say, one grid coordinates are selected from the list of available placement positions retrieved in Step S112. Here, for example, (20, 18) is selected and explanation is provided. An orderliness level of an object with Identification Number 4 if a position of the center of gravity of the object with Identification Number 4 is set to the selected coordinates is calculated.

A method of calculating an orderliness level is the same as the flow of Steps S122 to S127 in FIG. 7 and the flow of FIG. 7 is performed using the position of the object data of Identification Number 4 set to the coordinates (20, 18). The calculation result is 4, which is stored by linking the calculation result to the coordinates (20, 18) of the list of available placement positions retrieved in Step S112. The orderliness levels are calculated for all coordinates of the list of available placement positions retrieved in Step S112.

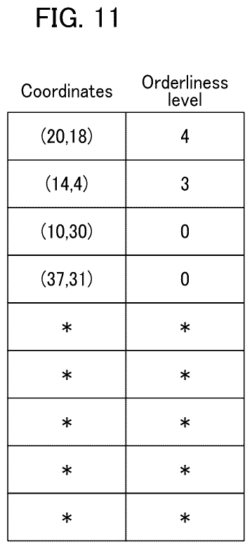

FIG. 11 is a diagram showing an example of a list of available placement positions when the process of Step S114 is completed in First Embodiment.

In Step S115, it is determined whether there is a placement position with an orderliness level of a reference value or more. That is to say, it is determined whether one or more placement positions with the orderliness level of the reference value or more exist in the list of available placement positions in FIG. 11 after the process of Step S114. If it is determined that the one or more placement positions do not exist, the process proceeds to the process of Step S117. On the other hand, if it is determined that the one or more placement positions exist, the process proceeds to the process of Step S116. Here, for example, since Orderliness Level 3 and Orderliness Level 4 of Reference Value 1 or more exist, the process proceeds to the process of Step S116.

In Step S116, an available placement position whose orderliness level has a maximum value is determined as a tidying-up destination. That is to say, the orderliness level in the list of available placement positions in FIG. 11 after the process in Step S114 is referenced and the coordinates linked to the maximum orderliness level are acquired.

The coordinates linked to the highest Orderliness Level 4 in the list of available placement positions in FIG. 11 are (20, 18). Therefore, the tidying-up position of the object data whose identification number is 4 is updated to the coordinates (20, 18). In this way, in Present Embodiment, a tidying-up destination is determined so that an orderliness level of the tidying-up destination is higher on the basis of the orderliness level of the tidying-up destination.

After that, the position itself of the object data whose identification number is 4 is updated by changing it to the coordinates (20, 18) described above. Furthermore, the position is updated by referring to the initial position of the object data whose identification number is 4 and adding a difference (−18, −14) between the initial position (38, 32) and the updated coordinates (20, 18) to the coordinates of the four corners of the object data whose identification number is 4.

The updated coordinates of the four corners are [(18, 16), (23, 16), (18, 20), (23, 20)]. Thus, when retrieving available placement positions after the process of Step S116, the position determined to be the movement destination in Step S116 is excluded from the retrieving target.

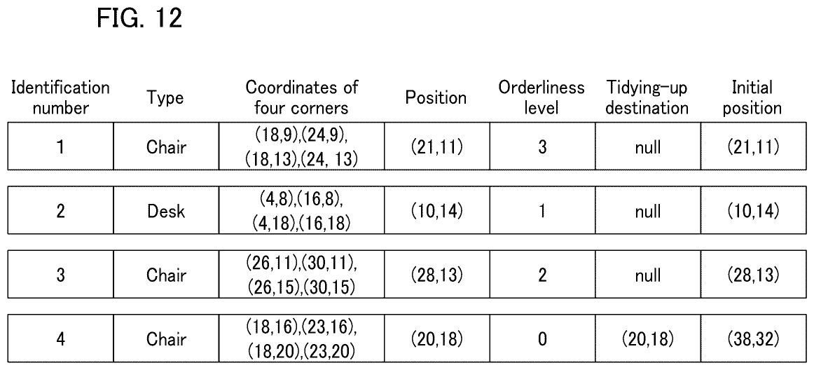

FIG. 12 is a diagram showing an example of a data structure of object data when the process of Step S116 is completed.

In Step S117, it is determined whether there is another object whose orderliness level is less than the reference value. That is to say, it is determined whether any other unselected identification numbers exist by referring to the list of “identification numbers of objects whose orderliness level is less than the reference value” stored in Step S141. If it is determined that the other unselected identification numbers exist, the process returns to the process of Step S111. If it is determined that the other unselected identification numbers do not exist, the process flow of FIG. 10 end.

After the process flow of FIG. 10 is completed, although the object data whose tidying-up destination is NULL is not tidied up, in the case of the object data whose tidying-up destination is other than NULL, tidying up of the object to the coordinates of the tidying-up destination is performed.

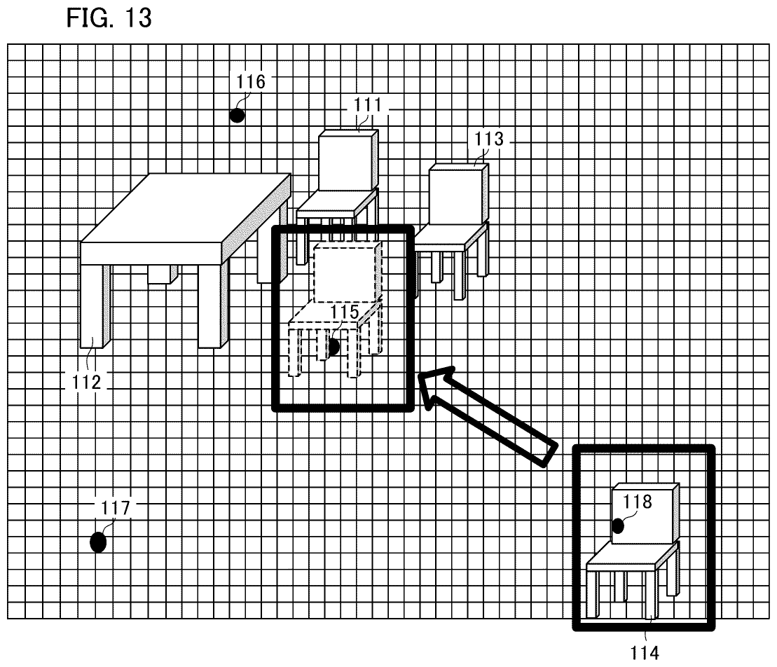

FIG. 13 is a diagram showing an example of determining a tidying-up destination on the basis of the image of FIG. 5 in First Embodiment. In FIG. 13, the coordinates of a grid 115 are (20, 18), the coordinates of a grid 116 are (14, 4), the coordinates of a grid 117 are (10, 30), and the coordinates of a grid 118 are (37, 31).

Through Step S116, the tidying-up destination of the chair 114 extracted using Identification Number 4 is determined to be the position of the grid 115 which has the coordinates (20, 18). As described above, according to First Embodiment, the tidying-up details can be determined in accordance with the “connected objects” existing in the vicinity of each object.

### Modified Example

In First Embodiment, a flag of “not tidying up” may be set in the object data. When object data less than the reference value is selected in Step S111 of FIG. 10, if object data whose flag of “not tidying up” is TRUE is selected, it may be determined not to perform tidying-up and the process may proceed to the process of Step S117.

Also, for example, the type of object may have a flag of “not tidying up” set to TRUE, for example, for an object that is a fixture object of a space (storage destination) shown in FIG. 1 or a heavy object with a predetermined weight or more which cannot be moved using the robot 1007.

In that case, when object detection is performed in Step S103, object data whose type is of a bookshelf or a chest of drawers may be determined to be a fixture object or a heavy object with a predetermined weight or more and a flag of “not tidying up” may be automatically set to TRUE. Thus, it is possible to only determine a tidying-up destination for other objects without moving an object such as fixture objects or heavy objects that are storage destinations and to reduce a processing load.

Also, in First Embodiment, in Step S141, the identification numbers of object data whose orderliness level is less than the predetermined reference value are stored in the list of “identification numbers of objects whose orderliness level is less than the reference value” by referring to the orderliness level of the object data.

Here, other methods may be used as long as object data whose an orderliness level is low can be selected. That is to say, for example, object data linked to a predetermined number of orderliness levels or orderliness levels of a predetermined percentage of numbers may be retrieved from object data with the lowest orderliness level by referring to the orderliness level of the object data. Furthermore, the identification numbers of those object data may be stored in the list of “identification numbers of objects whose orderliness level is less than the reference value.”

Also, in Step S112 of FIG. 10 in First Embodiment, all four sides of the object are in the region to be tidied up in FIG. 5, the coordinates of the grid in which the object and other objects do not overlap are retrieved and stored in the list of available placement positions, and the orderliness levels for all coordinates in the list of available placement positions are calculated. Here, the orderliness level may be calculated after further narrowing down the candidates for tidying-up places among the corresponding coordinates.

For example, by referring to the type of object data, only the coordinates of grids which exist within 200 cm of the position of the “connected object” may be left in the list of available placement positions and other coordinates may be removed from the list of available placement positions. Thus, when determining a tidying-up destination, positions which are relatively unlikely to have high orderliness levels are excluded, reducing an amount of calculations.

Moreover, although an orderliness level is calculated on the basis of the type of “connected object” and the position information in First Embodiment, the orderliness level may be calculated in accordance with a direction of the “connected object.” Thus, even for the same position, the orderliness level can be calculated differently in accordance with the direction of the object.

For example, at the time of object detection, if a chair with a back panel is detected, a vector from a center of the back panel of the chair toward a center of the seat can be linked to the object data as a “vector” and stored. Furthermore, if a desk is detected, a vector directed from the long side to the short side of the desk is linked to the object data as a “vector” and stored.

Furthermore, in addition to the addition value, a reference angle may be added to the data of the “connected object” shown in FIG. 8. For example, if the “type of object” is a desk and the “type of connected object” is a chair, the reference angle is set to, for example, 30 degrees.

In addition, an angle formed by the vector of the object data is calculated a difference between the angle and the above-described reference angle is calculated. If the difference between the angle and the reference angle is, for example, less than 15 degrees, 2 may be added to the orderliness level. Furthermore, when determining a tidying-up destination, after determining the position, a direction of the object may be designated so that the highest orderliness level is achieved.

### Second Embodiment

Although the tidying-up details are determined from only the orderliness level in First Embodiment, in Second Embodiment, if tidying-up is performed, in addition to the orderliness level, for example, the cost such as the time it takes for the robot to move is calculated and this cost is combined with the orderliness level to determine the tidying-up details.

FIG. 14 is a functional block diagram showing an example of a functional configuration of the information processing device 100 according to Second Embodiment. Functional blocks having the same functions as those in FIG. 2 are denoted by the same reference numerals and duplicated explanations thereof will be omitted.

In Second Embodiment, when the tidying-up details determination unit 105 determines the tidying-up details, a cost calculation unit 201 calculates the cost required for tidying up and a tidying-up destination is determined on the basis of the cost in addition to the orderliness level. Furthermore, a database 202 is connected to the information processing device 100 and the database 202 stores information such as a speed of the robot used for tidying up.

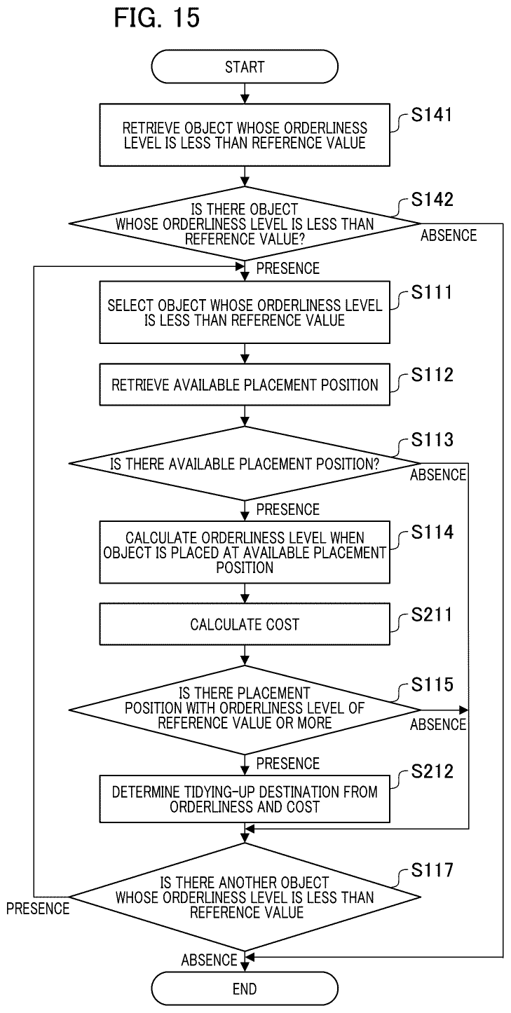

FIG. 15 is a flowchart for describing an example of a flow of a process of determining the details of tidying-up in Second Embodiment. In Second Embodiment, the same process flow as those in FIG. 4 is used. Furthermore, the same processes as those in FIG. 10 are denoted by the same reference numerals and duplicated explanations thereof will be omitted. The CPU serving as a computer of the information processing device 100 executes a computer program stored in a memory, thereby sequentially performing the operations of each step in the flowchart of FIG. 15.

Although the process of determining the tidying-up details in Step S105 in FIG. 4 are shown in detail in FIG. 15, Second Embodiment and First Embodiment differ in that, in Second Embodiment, a step of calculating the cost is added and a tidying-up destination is determined on the basis of the cost in addition to the orderliness level when determining a tidying-up destination.

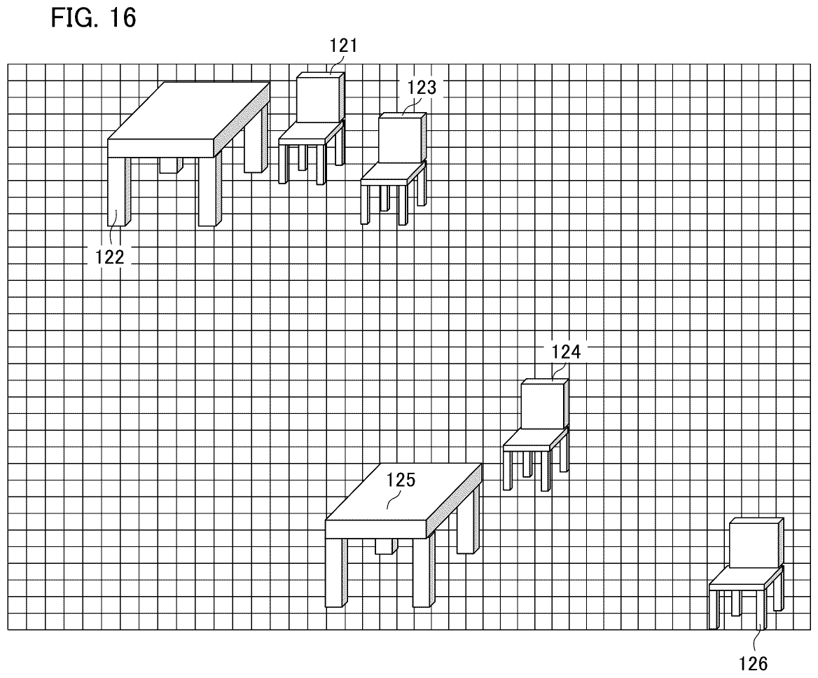

FIG. 16 is a diagram showing an example of an image acquired as a region to be tidied up in Second Embodiment and shows an example of an image acquired in Step S102 of Second Embodiment.

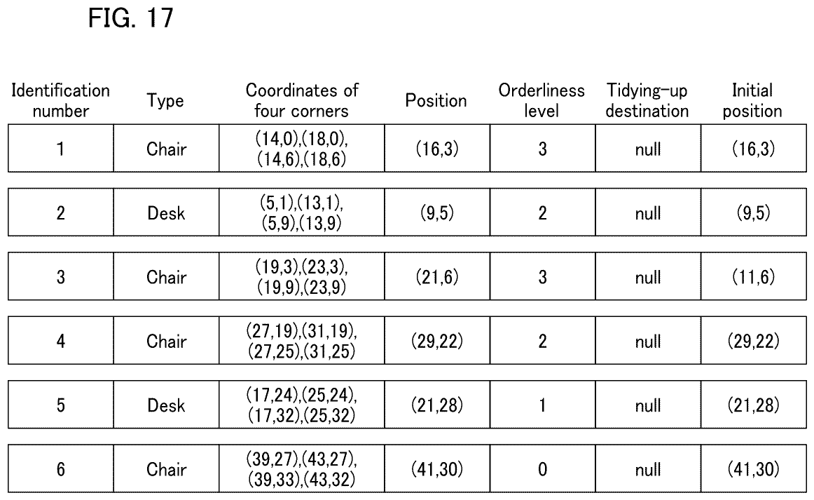

FIG. 17 is a diagram showing an example of an object data structure when an orderliness level is calculated in Step S104 in Second Embodiment and shows an example of a data configuration when the orderliness level is calculated in Step S104 on the basis of the object data derived in Step S103.

In FIG. 17, a chair 121 in FIG. 16 is extracted as Identification Number 1, a desk 122 is extracted as Identification Number 2, a chair 123 is extracted as Identification Number 3, and a chair 124 is extracted as Identification Number 4. Furthermore, a desk 125 is extracted as Identification Number 5 and a chair 126 is extracted as Identification Number 6. In Step S111 of FIG. 15, Identification Number 6 whose orderliness level is 0 is selected as an object whose orderliness level is less than the reference value.

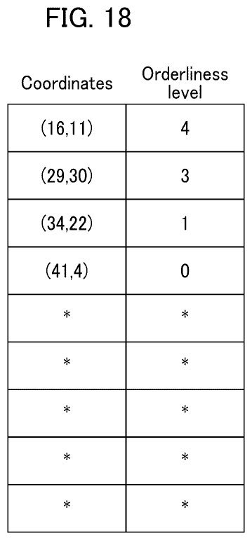

FIG. 18 is a diagram showing an example of a list of available placement positions when Step S114 in FIG. 15 in Second Embodiment is completed and shows an example of orderliness levels linked to the coordinates of available placement positions calculated in Step S114. Here, the coordinates (16, 11), (29, 30), (34, 22), and (41, 4) will be used as examples.

In Step S211 of FIG. 16, the cost calculation unit 201 of the information processing device 100 calculates the cost. One coordinate is selected from the list of available placement positions in FIG. 18. For example, (16, 11) is selected and an explanation is provided. A distance between the selected coordinates (16, 11) and the coordinates (41, 30) of the position of the object data of Identification Number 6 in FIG. 17 is calculated.

The distance is calculated by applying Pythagoras' theorem to the coordinates between two points and multiplying it by a length of one side of the grid. The calculated distance is 314 cm. Subsequently, the speed of the robot used for tidying up is acquired from the database 202 and the time it takes for the robot used for tidying up to move by the distance between the two points is calculated by dividing the distance by the speed of the robot.

If the speed of the robot used in Second Embodiment is, for example, 100 cm/sec, the time required for movement is 3.14 seconds. In Present Embodiment, the cost is calculated by dividing the calculated time required for movement by a predetermined unit time. In Present Embodiment, as an example, the unit time is 1 second. Thus, the cost is set to 3.14. The calculated cost is linked to the selected coordinates in the list of available placement positions and stored. Furthermore, the cost is calculated for every coordinate in the list of available placement positions.

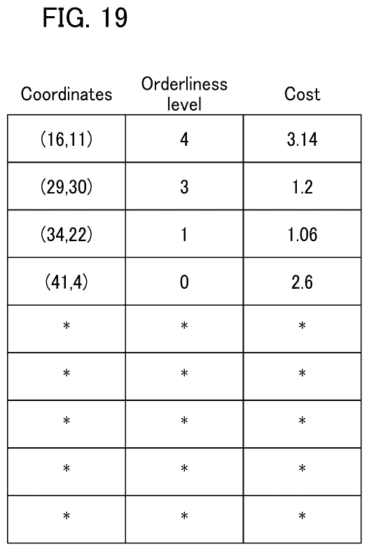

FIG. 19 is a diagram showing an example of a list of available placement positions when the process of Step S211 in Second Embodiment is completed. In this way, Step S211 functions as a cost calculation step (cost calculation unit) which calculates the cost required for moving an object to a tidying-up destination on the basis of the type of object and the position thereof.

In Step S212 of FIG. 16, one coordinate is selected from the list of available placement positions in FIG. 19. For example, a case where (16, 11) is selected will be described. In Present Embodiment, a value obtained by subtracting the cost from the orderliness level linked to the selected coordinates (16, 11) of the list of available placement positions is calculated.

If the cost is subtracted from the orderliness level, since the orderliness level is 4 and the cost is 3.14, the result is 0.86. The calculated value is used as the determination value, linked to the selected coordinates in the list of available placement positions, and stored. Furthermore, the determination value is calculated for every coordinate in the list of available placement positions.

In this way, in Step S212, a tidying-up destination is determined on the basis of the orderliness level and the cost. Tidying-up destinations with a high determination value tend to have a high orderliness level or low costs, making them more desirable candidates for movement destinations.

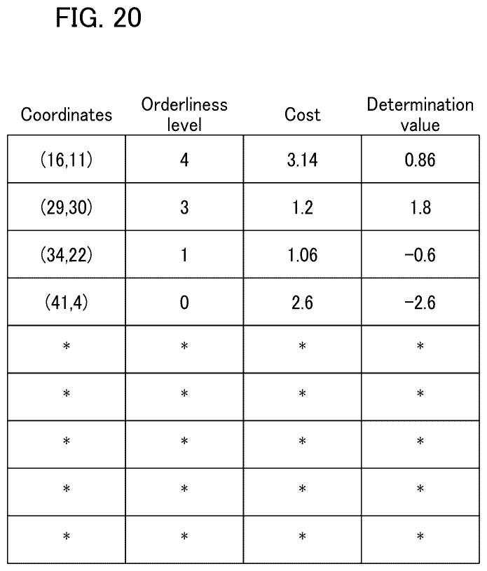

FIG. 20 is a diagram showing an example of a list of available placement positions after a determination value is calculated in Step S212 in Second Embodiment. From the list of available placement positions in FIG. 20, the coordinates linked to a determination value that is a maximum value are acquired. In the example of FIG. 20, the determination value that is a maximum value is 1.8 and the linked coordinates are (29, 30). In Step S212 in FIG. 16, the tidying-up destination of the object data of Identification Number 6 in FIG. 17 is updated to the acquired coordinates (29, 30).

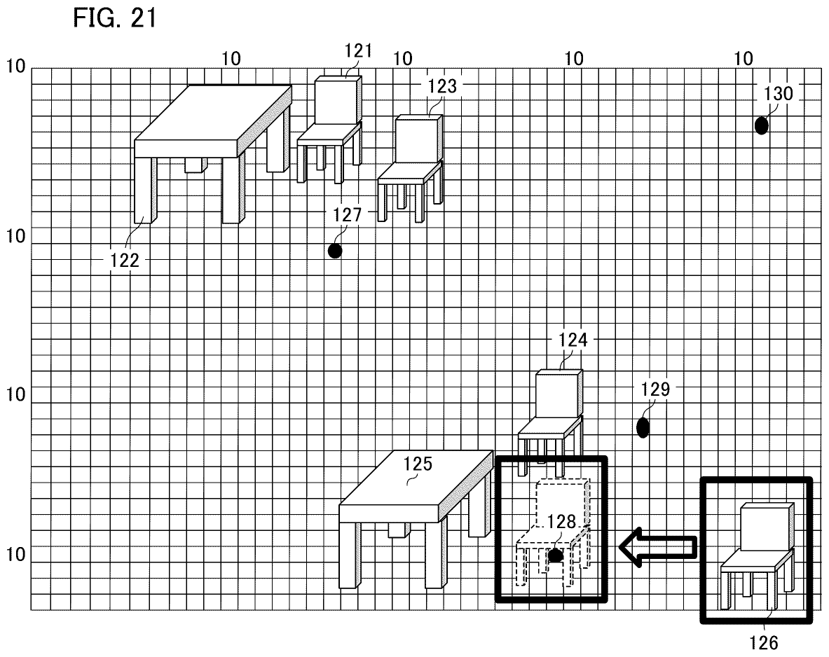

FIG. 21 is a diagram for explaining an example of determining a tidying-up destination on the basis of the image in FIG. 16 in Step S212 in FIG. 16 in Second Embodiment. The coordinates of a grid 127 in FIG. 21 are (16, 11), the coordinates of a grid 128 are (29, 30), the coordinates of a grid 129 are (34, 22), and the coordinates of a grid 130 are (41, 4).

In Step S212 in FIG. 16, a tidying-up destination of the chair 126 extracted using Identification Number 6 in FIG. 17 is determined to be the grid 128 which is in the coordinates (29, 30). According to the method described above, a tidying-up destination requiring less cost can be determined.

### Modified Example

Although an example in which the time it takes for the robot to move is the cost has been explained in Second Embodiment, the present invention is not limited thereto. For example, the probability of an object being damaged if tidying up is performed may be used as the cost. In this case, the probability of damage according to the movement distance is set and stored in the database 202 for each type of object.

Also, in Step S211 of FIG. 16, the probability of damage is acquired from the database 202 on the basis of the distance from the position of the object to the coordinates of the list of available placement positions and the type of object. Furthermore, the probability of damage is divided by the unit probability of a predetermined value and acquired as the cost. If the probability of damage increases, the costs for tidying up will also increase.

Moreover, an amount of electricity used by the robot for tidying up may be used as the cost. In that case, the amount of electricity is acquired by setting an amount of electricity consumed in accordance with the movement distance of the robot and storing it in the database and designating the distance from the position of the object to the coordinates of the list of available placement positions in Step S211 of FIG. 16. A value obtained by dividing the acquired amount of electricity by a predetermined unit amount of electricity is set to the cost. If the amount of electricity if tidying up is performed increases, the cost also increases.

Also, an upper limit value may be set to the cost, and when determining a tidying-up destination in Step S212 of FIG. 16, coordinates whose cost linked to the coordinates is an upper limit value or more may be excluded from the list of available placement positions. As a result, if the candidates for an available placement position do not exist in the list of available placement positions, it is determined that tidying up is not performed and the process proceeds to the process of Step S117.

In the above description, in an upper limit of the cost, an upper limit value may be designated by the user or may be obtained from the ROM 1102. By configuring in this way, it is possible to determine a tidying up method which will result in a higher orderliness level while keeping the cost required for tidying up within the upper limit.

Also, in Second Embodiment, a determination value is calculated based on the cost necessary for tidying up and the orderliness level and a tidying-up destination is determined. Here, the determination value may be calculated by weighting the orderliness level and the cost and then subtracting them or the weights may be adjusted. In that case, for example, the weights may be adjusted by changing the unit time used for division when calculating the cost.

Thus, a tidying-up destination can be determined by placing more importance on one of the orderliness level and the cost and the tidying-up destination is changed in accordance with the weight. When calculating the determination value in Step S212, the orderliness level and the cost are subtracted, but the determination value may be calculated through division.

### Third Embodiment

In First Embodiment, if a “connected object” exists in the vicinity, the object is defined as being in a state of being tidied up. On the other hand, in the third embodiment, a degree to which a placement relationship of a group of objects of a predetermined type approximates a predetermined placement relationship is defined as an orderliness level, an object with a low orderliness level is selected as a tidying-up target, and a tidying-up destination is determined so that the placement relationship becomes the predetermined placement relationship.

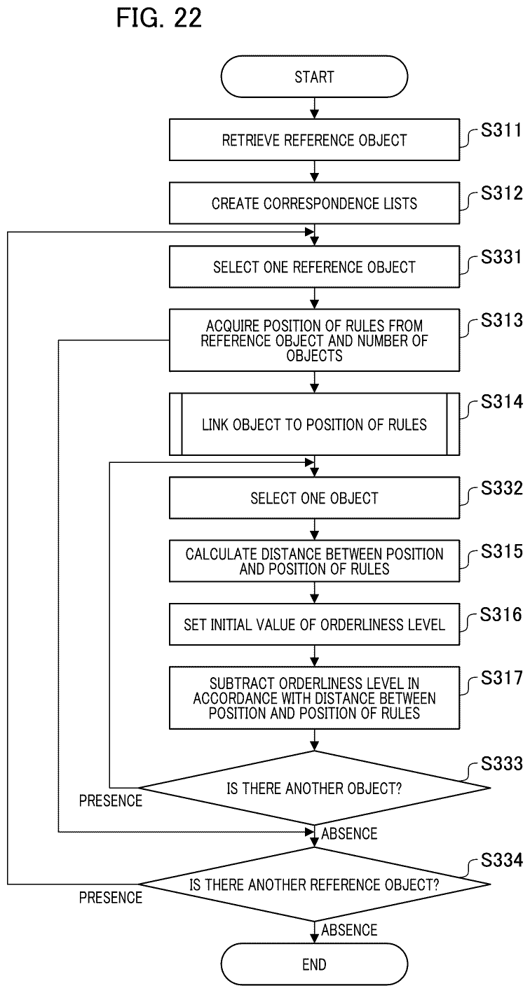

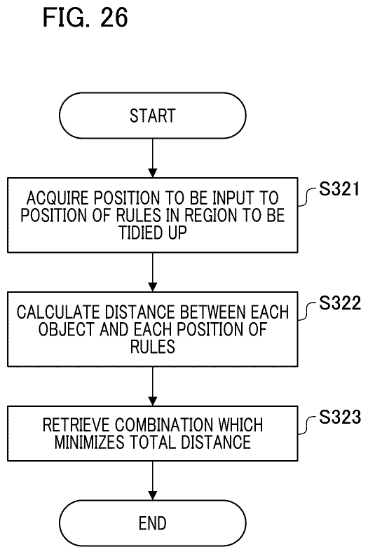

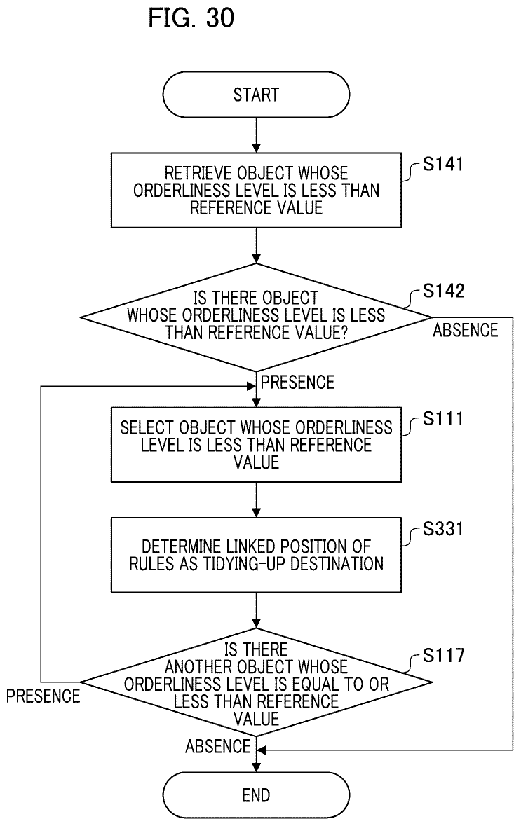

Although the configuration of the information processing device 100 in Third Embodiment is the same as that in FIG. 2 and the processing flow is the same as that in FIG. 5, the processing details of Steps S104 and S105 in FIG. 4 are different. The flow of the process of Step S104 in Third Embodiment will be described below with reference to the flowcharts of FIGS. 22 and 26 and the flow of the process of Step S105 in Third Embodiment will be described below with reference to the flowchart of FIG. 30.

FIG. 22 is a flowchart for describing an example of a flow of an orderliness level calculation in Step S104 in Third Embodiment. The same processes as those in FIG. 4 are denoted by the same reference numerals and duplicated explanations thereof will be omitted. The CPU serving as a computer of the information processing device 100 executes a computer program stored in a memory, thereby sequentially performing the operations of each step in the flowchart of FIG. 22.

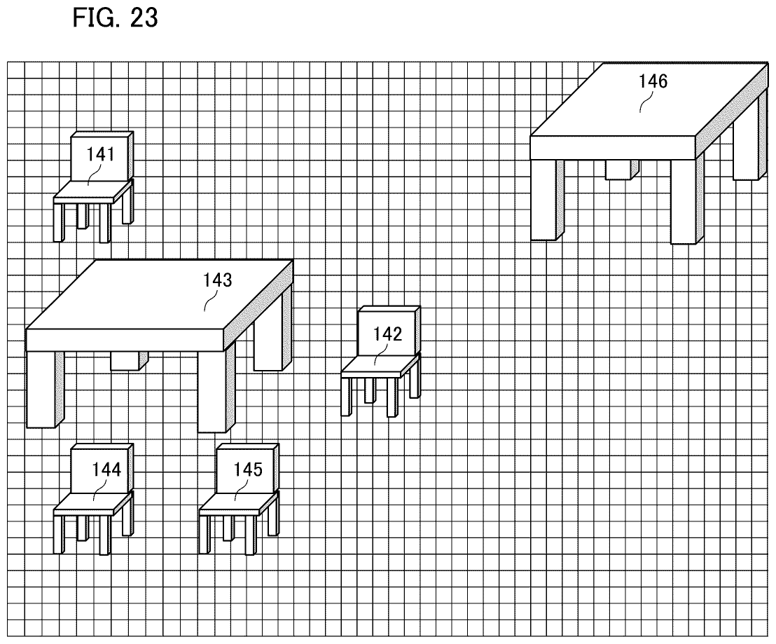

FIG. 23 is a diagram showing an example of an image acquired as a region to be tidied up in Step S102 in Third Embodiment.

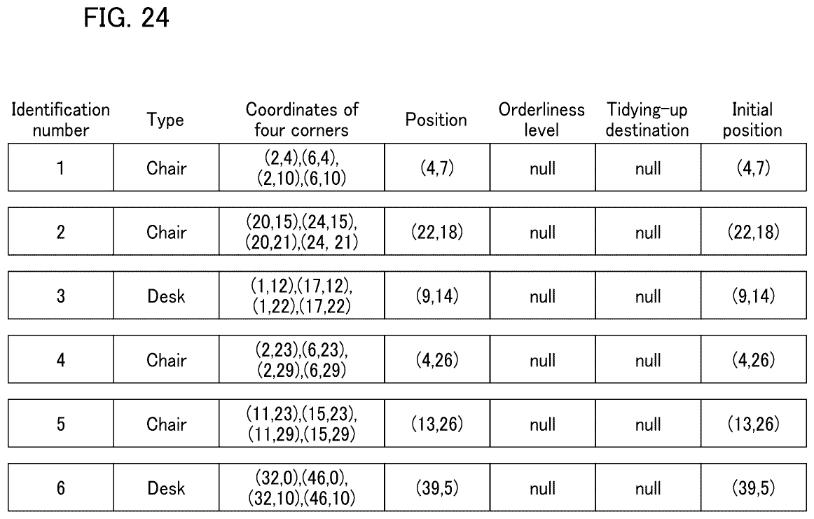

FIG. 24 is a diagram showing an example of a data structure of object data derived in Step S103 in Third Embodiment.

A chair 141 in FIG. 23 is extracted as Identification Number 1 in FIG. 24, a chair 142 is extracted as Identification Number 2, a desk 143 is extracted as Identification Number 3, a chair 144 is extracted as Identification Number 4, a chair 145 is extracted as Identification Number 5, and a desk 146 is extracted as Identification Number 6.

In Step S311 in FIG. 22, a reference object which exists in a region to be tidied up is retrieved. The reference object is an object which serves as an index for calculating an orderliness level of an object of a predetermined type.

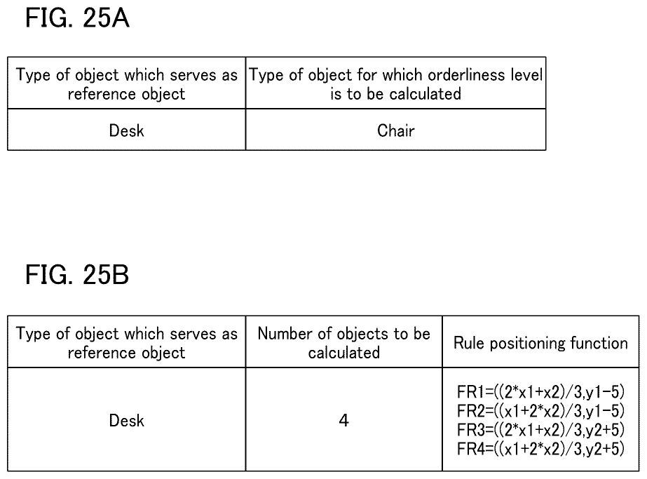

The above reference object data is stored in the ROM 1102. The reference object data is read-only data, and as shown in FIGS. 25A and 25B, a “type of object for which an orderliness level is to be calculated” is stored in linkage with the “type of object which serves as a reference object.”

FIGS. 25A and 25B are diagrams showing examples of reference object data and data regarding the “position of rules” in Third Embodiment. FIG. 25A is a diagram showing an example of reference object data used in Present Embodiment, in which a desk is stored as the “type of object which serves as a reference object.” Furthermore, a chair is stored as the “type of object for which an orderliness level is to be calculated” linked to a desk.

In Third Embodiment, as shown in FIG. 25A, although the type of object which serves as a reference object is set to a desk and the type of object for which an orderliness level is to be calculated is set to a chair, the types are not limited to these. Furthermore, the plurality of types of objects which serve as reference objects and the plurality of types of objects for which an orderliness level is to be calculated may be provided.

In Step S311, the reference object data in the ROM 1102 is referenced to acquire a “desk” as the “type of object which serves as a reference object” and a “chair” as the “type of object for which an orderliness level is to be calculated.”

Also, in the type of object data in FIG. 24, the identification number that matches a “desk” that is the “type of object which serves as a reference object” is stored as a reference object list. As a result, since the type of object data of Identification Numbers 3 and 6 is a “desk,” 3 and 6 are stored in the reference object list.

Subsequently, in Step S312, correspondence lists are created by the number of elements in the reference object list. In the above example, since two object data which have 3 and 6 exist in the reference object list, two correspondence lists are created.

Subsequently, in Step S331, one identification number is selected from the reference object list stored in Step S312. Here, for example, Identification Number 3 is selected. Furthermore, the selected Identification Number 3 is assigned as an identifier for the correspondence list. That is to say, since the selected identification number is 3, the result is Correspondence List 3. Similarly, for every identification number in the reference object list, an identification number is assigned to the correspondence list.

Furthermore, the type of object data in FIG. 24 is referenced and one of the object data that matches the “type of object for which an orderliness level is to be calculated” in FIG. 25A is selected. In FIG. 25A, since the “type of object for which an orderliness level is to be calculated” is a chair, Identification Number 1 whose type matches the type in the object data in FIG. 24 is first selected.

Subsequently, the position of the object data of the selected Identification Number 1 is acquired and each distance between this position and the positions of the object data of the identification numbers (3 and 6 in this example) for all objects stored in the reference object list is calculated. Furthermore, the identification number of the object in the reference object list with the smallest distance is acquired.

For example, in FIG. 24, the position of the object data of Identification Number 1 is (4, 7), the position of the object data with Identification Number 3 stored in the reference object list is (9, 14), and the position of the object data with Identification Number 6 is (39, 5). Therefore, a distance between the position (4, 7) and the position (9, 14) is 86 cm and a distance between the position (4, 7) and the (39, 5) is 350 cm.

Therefore, the identification number of the object in the reference object list with the smallest distance is 3. Subsequently, Identification Number 1 selected in the “type of object for which an orderliness level is to be calculated” is added to Correspondence List 3 which has the identifier of Identification Number 3 with the smallest distance. That is to say, a chair with Identification Number 1 is added to Correspondence List 3 corresponding to a desk with Identification Number 3.

When all chairs are subjected to the above process and the process of Step S312 is completed, Identification Numbers 1, 2, 4, and 5 of the objects exist in Correspondence List 3 and an identification number of an object does not exist in Correspondence List 6. That is to say, in FIG. 23, since a plurality of chairs are closer to a desk 146 which serves as a reference object than to a desk 143 which serves as a reference object, they are added to Correspondence List 3 of the desk 143.

Subsequently, in Step S331, one reference object is selected. That is to say, one reference object identification number is selected from the reference object list stored in Step S311. Here, Identification Number 3 is selected.

In Present Embodiment, the ROM 1102 stores predetermined data regarding the “position of rules,” which is used in Step S331. Data regarding the “position of rules” corresponds to a read-only relational database and is retrieved as a “rule positioning function” using the “type of object which serves as a reference object” and the “number of objects to be calculated” as composite keys.

The “rule positioning function” is a function which uses the coordinates of the four corners of the reference object as arguments and has, a return value, the coordinates of the “position of rules” by the same number as the number of objects to be calculated and is stored in the ROM 1102. The “position of rules” is a coordinate and is used for orderliness level calculation in the process flow of FIG. 22.

FIG. 25B is a diagram showing an example of data regarding the “position of rules” used in Third Embodiment. In FIG. 25B, if the “type of object which serves as a reference object” is a desk and the “number of objects to be calculated” is 4, the following four functions are acquired as data regarding the “position of rules.”

$$FR 1 ( x 1 , x 2 , y 1 , y 2 ) = ( ( 2 * x 1 + x 2 ) / 3 , y 1 - 5 )$$

$$FR 2 ( x 1 , x 2 , y 1 , y 2 ) = ( ( x 1 + 2 * x 2 ) / 3 , y 1 - 5 )$$

$$FR 3 ( x 1 , x 2 , y 1 , y 2 ) = ( ( 2 * x 1 + x 2 ) / 3 , y 2 + 5 )$$

$$FR 4 ( x 1 , x 2 , y 1 , y 2 ) = ( ( x 1 + 2 * x 2 ) / 3 , y 2 + 5 )$$

The arguments x1, x2, y1, and y2 of the function are explained. The coordinates of the four corners of the object data in FIG. 24 are the coordinates of the four grids in which the vertices of a rectangle are positioned, in which the grids as shown in FIG. 23 which are occupied by the object extracted in Step S103 approximate the rectangle.

Since the grids approximate a rectangle, there are two types of numerical values for the x and y coordinates of the coordinates of the four corners. A minimum value of the x coordinates of the coordinates of the four corners is set to x1 and a maximum value is set to x2. Furthermore, a minimum value of the y coordinates is set to y1 and a maximum value is set to y2. In the data regarding the “position of rules,” the “type of object which serves as a reference object” and the “number of objects to be calculated” are not limited to a desk or 4.

In Step S313, data regarding the “position of rules” is acquired from the reference object and the number of objects. That is to say, the type (desk) of the object data of Identification Number 3 and the number of elements (4) of Correspondence List 3 having the same identifier as Identification Number 3 in the reference object list selected in Step S331 are acquired.

Also, a “desk” is input to the “type of object which serves as a reference object” of the data regarding the “position of rules” for the data regarding the “position of rules” and 4 is input to the “number of objects to be calculated” so that a “rule positioning function” is acquired. Furthermore, if the “number of objects to be calculated” is 0 in Step S313, the process proceeds to the process of Step S334.

In Step S314, the object to be calculated is linked to the “position of rules.” The details of the process in Step S314 will be explained with reference to the flowchart in FIG. 26.

FIG. 26 is a flowchart showing an example of a flow of linking the object and the “position of rules” in Step S314 in Third Embodiment. The CPU serving as a computer of the information processing device 100 executes a computer program stored in a memory, thereby sequentially performing the operations of each step in the flowchart of FIG. 26.

In Step S321 in FIG. 26, a position to be input to the “position of rules” in the region to be tidied up is acquired. That is to say, in Step S331 in FIG. 22, the coordinates of the four corners [(1, 12), (17, 12), (1, 22), (17, 22)] of the object data of Identification Number 3 selected from the reference object list are acquired.

Subsequently, first, one of functions of determining a “position of rules” acquired in Step S314 is selected. Here, FR1 (x1, x2, y1, y2)=((2*x1+x2)/3, y1−5) is selected and explained. The above coordinates of the four corners are substituted with the argument of the selected rule positioning function to acquire the coordinates of the “position of rules.”

The above coordinates of the four corners are, for example, x1=1, x2=17, y1=12, and y2=22. By substituting these with the above function, for example, the coordinates (4.67, 7) are acquired. The acquired coordinates are linked to the number of the “position of rules” and stored. If the coordinates are calculated using all four position functions of rules in FIG. 25B, the coordinates of the following four “position of rules” are acquired. If the coordinates include decimals, round them down to the nearest integer, as follows: (5, 7), (12, 7), (5, 27), (12, 27).

In Step S322 in FIG. 26, a distance between each object and each “position of rules” is calculated. That is to say, table data of distances between the objects and the “positions of rules” is created. In Step S331 in FIG. 22, by referring to the correspondence list linked to the identification number selected from the reference object list, the horizontal axis represents the identification number stored in the correspondence list and the vertical axis represents the coordinates of the “position of rules” acquired in Step S321.

A distance between the coordinates of the object data of the identification number on the horizontal axis and the coordinates of the “position of rules” on the vertical axis is calculated and stored in the table data. Distances for all of the coordinates on the horizontal axis and the vertical axis are calculated and stored in the table data.

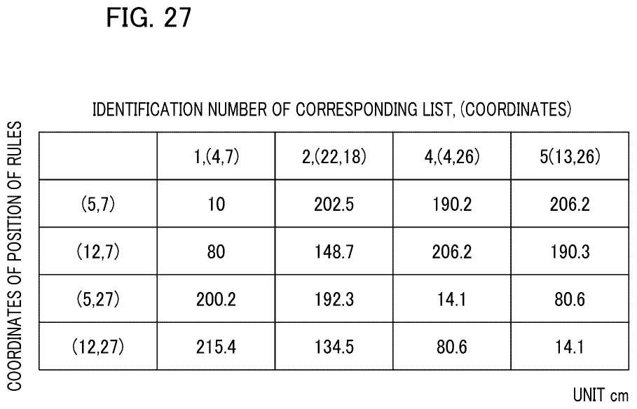

FIG. 27 is a diagram showing an example of table data of a distance between a “position of rules” created in Step S322 in Third Embodiment and a position of object data.

In Step S323, a combination which minimizes the total distance is retrieved. That is to say, by referring to the table data in FIG. 27 stored in Step S322, if the vertical and horizontal axes are each called only once, a combination which minimizes the total distance in the table is retrieved.

The combinations of the retrieving results are [1, (5, 7)], [2, (12, 7)], [4, (5, 27)], and [5, (12, 27)] as the [identification numbers in the correspondence list, (coordinates of the “position of rules”)]. The object data of the selected identification number from the correspondence list is placed on the horizontal axis and the “position of rules” on the vertical axis which is combined with the object data is added and stored.

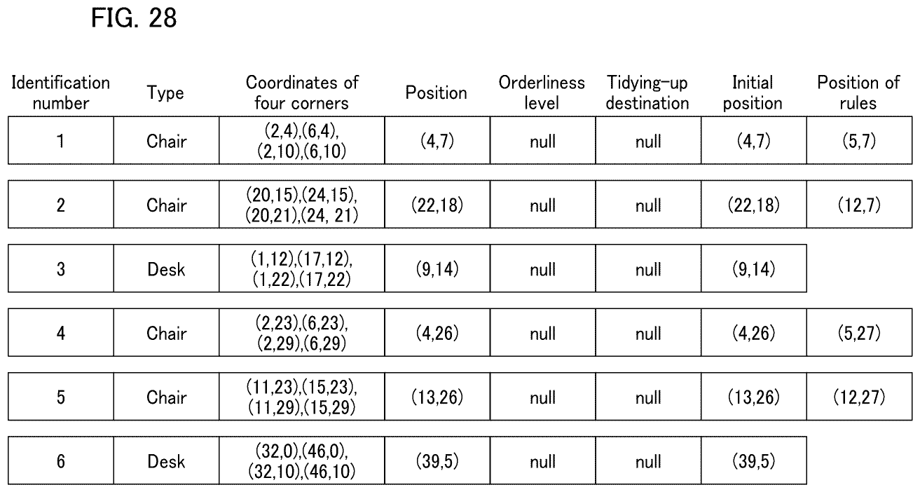

FIG. 28 is a diagram showing an example of a data structure of object data when Step S323 is completed in Third Embodiment.

In Step S332, one object is selected. That is to say, in Step S331, Correspondence List 3 linked to Identification Number 3 selected from the reference object list is referenced and one of the identification numbers stored in Correspondence List 3 is selected. Here, a case where Identification Number 1 is selected will be described.

In Step S315, a distance between the position and the “position of rules” is calculated. That is to say, the position (4, 7) and the “position of rules” (5, 7) of the object data of Identification Number 1 selected in Step S332 are acquired and a distance between the two points is calculated. The calculated distance is 10 cm.

In Step S316, an initial value of the orderliness level is set. That is to say, an orderliness level of the object data of Identification Number 1 selected in Step S332 is updated to the initial value. In Present Embodiment, the initial value is set to 10.

In Step S317, the orderliness level is subtracted in accordance with the distance from the “position of rules.” That is to say, the distance calculated in Step S315 is divided by a unit distance to acquire a value. In Present Embodiment, the unit distance is set to 10 cm. Therefore, 1 is calculated.

On the other hand, the orderliness level (10) of the object data of Identification Number 1 selected in Step S332 is acquired and a value obtained by subtracting 1 from the acquired orderliness level (10) is calculated. The calculation result is 9 and the orderliness level of the object data of the identification number selected in Step S332 is updated to the calculated value of 9.

In Step S333, it is determined whether there are other objects. That is to say, it is determined whether there is an identification number of identification numbers in Correspondence List 3 which have not been selected in Step S332. If it is determined that there is the identification number, the process proceeds to the process of Step S332. In addition, if it is determined that there is no identification number, the process proceeds to the process of Step S334.

In Step S334, it is determined whether there are any other reference objects. That is to say, it is determined whether there is an identification number of identification numbers in the reference object list which have not been selected in Step S331. If it is determined that there is the identification number, the process proceeds to the process of Step S331. In addition, if it is determined that there is no identification number, the process flow in FIG. 22 ends.

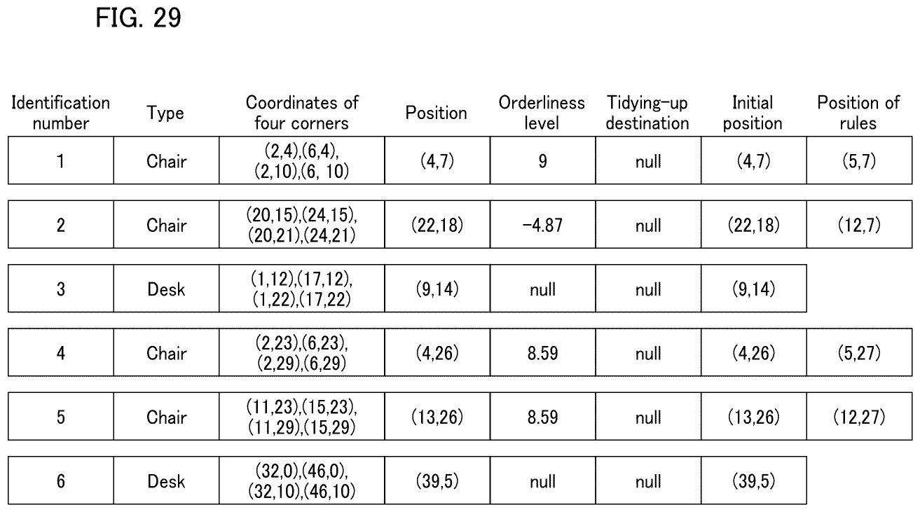

FIG. 29 is a diagram showing an example of a data structure of object data when Step S334 in Third Embodiment is completed. As shown in FIG. 29, the result of subtracting an orderliness level in accordance with a distance from the “position of rules” is stored.

FIG. 30 is a flowchart for describing an example of a flow of determining the details of tidying-up in Third Embodiment. The CPU serving as a computer of the information processing device 100 executes a computer program stored in a memory, thereby sequentially performing the operations of each step in the flowchart of FIG. 30.

The same processes as those in FIG. 7 in First Embodiment are denoted by the same reference numerals and duplicated explanations thereof will be omitted. Here, in FIG. 29, a method of determining a tidying-up destination for object data with Identification Number 2 which has an orderliness level of −4.87 that is less than a reference value of 1 is explained.

In Step S331 in FIG. 30, the “position of rules” in FIG. 29 of the object data of Identification Number 2 selected in Step S111 in FIG. 30 is referenced and the “position of rules” (12, 7) is acquired. Furthermore, the tidying-up destination of the object data of the identification number selected in Step S111 is updated to the referenced coordinates.

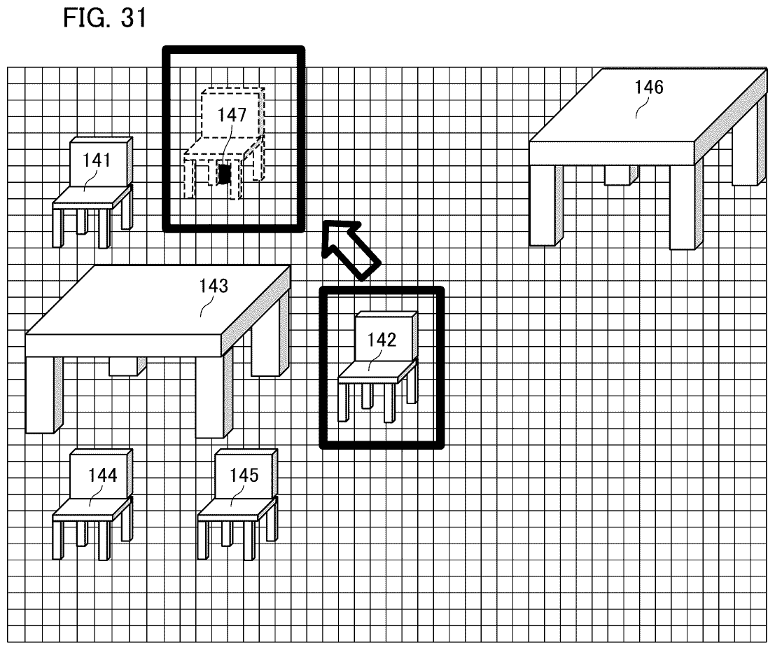

FIG. 31 is a diagram showing an example of determining a tidying-up destination on the basis of the image of FIG. 23 in Third Embodiment. The coordinates of a grid 147 are (12, 7), and a tidying-up destination of a chair 142 extracted using Identification Number 2 is determined to be the grid 147 which has the coordinates (12, 7).

In this way, in Third Embodiment, it is possible to select and tidy up objects which are irregularly arranged from among a plurality of objects.

### Modified Example

Based on the environment information, a position of a wall in a region to be tidied up may be acquired and used as a reference object. That is to say, the wall is extracted as an object, reference object data in which the “type of reference object” is the wall and the “type of object for which an orderliness level is to be calculated” linked to the wall is stored in the ROM 1102, and these pieces of data are acquired.

Thus, even if an object which serves as a reference object does not exist, it is possible to acquire a “position of rules” and it is possible to determine a tidying-up destination.

Also, when calculating an orderliness level, directions of an object which serves as a reference object and a target object for which an orderliness level is to be calculated may be acquired and the orderliness level may be added or subtracted. In that case, a reference angle is added and linked to the reference object data and stored in the ROM 1102 and an angle of a vector of the object which serves as a reference object and an object for which an orderliness level is to be calculated are referenced. If a difference between this angle and a reference angle is a predetermined value or more, the orderliness level is subtracted. If the above difference is less than the predetermined value, the orderliness level may be added.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing device or the like through a network or various storage media. Then, a computer (or a CPU, an MPU, or the like) of the information processing device or the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-087047, filed on May 29, 2024, which is hereby incorporated by reference herein in its entirety.

What is claimed is:

1. An information processing device comprising:
at least one processor or circuit configured to function as:
an environment information acquisition unit configured to acquire environment information regarding objects existing in a predetermined region;
an object information calculation unit configured to calculate a type of each of the objects and a position of the object relating to one or more of the objects on the basis of the environment information; and
a tidying-up details determination unit configured to determine a tidying-up destination of the object on the basis of the type and the position.

2. The information processing device according to claim 1, wherein the tidying-up details determination unit is configured to determine the tidying-up destination on the basis of a relevance of the types and distances of the plurality of objects.

3. The information processing device according to claim 1, wherein the at least one processor or circuit is further configured to function as an orderliness level calculation unit configured to calculate an orderliness level of the object on the basis of the relevance of the types and the distances of the plurality of objects,
wherein the tidying-up details determination unit is configured to determine the tidying-up destination on the basis of the orderliness level.

4. The information processing device according to claim 3, wherein the tidying-up details determination unit is configured to determine the tidying-up destination so that the orderliness level increases.

5. The information processing device according to claim 3, wherein the orderliness level calculation unit is configured to perform calculation so that, as the relevance increases, the orderliness level increases.

6. The information processing device according to claim 3, wherein the at least one processor or circuit is further configured to function as a cost calculation unit configured to calculate a cost necessary for moving the object to the tidying-up destination on the basis of the type and the position of the object,
wherein the tidying-up details determination unit is configured to determine the tidying-up destination on the basis of the orderliness level and the cost.

7. The information processing device according to claim 3, wherein the orderliness level calculation unit is configured to calculate the orderliness level on the basis of a regularity of a positional relationship of the plurality of objects.

8. The information processing device according to claim 3, wherein the tidying-up details determination unit is configured to determine the tidying-up destination on the basis of the orderliness level of the tidying-up destination.

9. The information processing device according to claim 1, wherein the at least one processor or circuit is further configured to function as a moving unit configured to move the object to the tidying-up destination on the basis of the tidying-up destination.

10. An information processing method comprising:
acquiring environment information regarding objects existing in a predetermined region;
calculating one or more types of the objects and a position of each of the objects on the basis of the environment information; and
determining a tidying-up destination of the object on the basis of the type and the position.

11. A non-transitory computer-readable storage medium configured to store a computer program to execute the following processes:
acquiring environment information regarding objects existing in a predetermined region;
calculating one or more types of the objects and a position of each of the objects on the basis of the environment information; and
determining a tidying-up destination of the object on the basis of the type and the position.
